(19) United States
(12) Patent Application Publication
(10) Pub. No.: US 2017/0017434 A1
(43) Pub. Date: Jan. 19, 2017

(54) SEMICONDUCTOR MEMORY DEVICE HAVING ADAPTIVE PAGE SIZE CONTROL

(71) Applicants: Jong-Min BANG, Hwaseong-si (KR); BokGue PARK, Hwaseong-si (KR)

(72) Inventors: Jong-Min BANG, Hwaseong-si (KR); BokGue PARK, Hwaseong-si (KR)

(21) Appl. No.: 15/095,350

(22) Filed: Apr. 11, 2016

(30) Foreign Application Priority Data
Jul. 17, 2015 (KR) 10-2015-0101804

(51) Int. Cl. G06F 3/06

(52) U.S. Cl. CPC G06F 3/0659; G06F 3/0604; G06F 3/0661; G06F 3/0644; G06F 3/0679

(57) ABSTRACT

Disclosed is a semiconductor memory device. The semiconductor memory device includes a memory cell array including a plurality of pages each storing data, a decoder configured to decode an address and a command, and a control circuit configured to allow a part or all of a selected page to be opened according to page size selection information which is applied in an active operating mode where the selected page of the plurality of pages is opened.

### CROSS-REFERENCE TO RELATED APPLICATION

This application claims priority under 35 U.S.C. §119 to Korean Patent Application No. 10-2015-0101804, filed Jul. 17, 2015, in the Korean Intellectual Property Office, the disclosure of which is incorporated by reference herein in its entirety.

### BACKGROUND

The present disclosure relates to a semiconductor memory device, and more particularly, to a semiconductor memory device capable of adaptively adjusting the size of a page to be opened at a row access operation.

A semiconductor memory device such as a dynamic random access memory (DRAM) is widely used as a main memory of an electronic system. A demand for a high-speed and low-power DRAM may increase according to a user's demand for the electronic system. In particular, a mobile-oriented semiconductor memory device such as a low-power double data rate (LPDDR) synchronous DRAM (SDRAM) may be used for mobile electronic devices such as a smart phone, a tablet PC, an ultra-book, and the like.

As the size of a mobile operating system (OS) becomes greater to support multi-tasking of a mobile electronic devices, a mobile DRAM may need to operate at high speed with less power consumption. Where the mobile electronic device includes an application processor (AP) with multiple cores, a low power memory device such as LPDDR SDRAM may be utilized as a working memory for the AP.

### SUMMARY

Embodiments of the inventive concepts provide a semiconductor memory device capable of reducing power consumption at a row access operation.

An embodiment of the inventive concept is directed to provide a semiconductor memory device which includes a memory cell array including a plurality of pages each storing data, a decoder configured to decode an address and a command, and a control circuit configured to allow a part or all of a selected page to be opened according to page size selection information which is applied in an active operating mode where the selected page of the plurality of pages is opened.

In some embodiments, the page size selection information may be applied to the decoder in an on the fly (OTF) manner.

In some embodiments, when the page size selection information indicates that a part of the selected page is opened, the portion of the selected page to be opened may be determined according to open page selection information. The open page selection information may be a bit of a column address.

In some embodiments, when the selected page is determined to be opened entirely, the open page selection information may be ignored. When a part of the selected page is determined to be opened, the part of the selected page may be an even page or an odd page of the selected page.

In some embodiments, the page size selection information may be applied to the row decoder in an on the fly (OTF) manner, and an operating condition may be set in a mode register set mode before the active operation.

In some embodiments, if a part of the selected page is opened, a column is selected only in the part of the selected page with a column address.

An embodiment of the inventive concept is directed to provide a semiconductor memory device having a memory cell array including a plurality of pages, each page configured to store data, a decoder configured to decode an address and a command, and a control circuit configured to open a part or all of a selected page in response to page size selection information, wherein the page size selection information is applied during active operation to open the selected page.

If a part of a page selected by the row address is opened in an active operating mode in which the page is opened, the portion of the page to be opened may be determined according to a bit of a column address under a control of the control circuit. The bit of the column address may be an MSB of the column address. In some embodiments, the page size open setting mode may be a mode register set mode. In some embodiments, the size of portion of the page to be opened may be half the page or a quarter of the page.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram illustrating a memory system including a semiconductor memory device according to an exemplary embodiment of the inventive concept;

FIG. 2 is a block diagram illustrating a part of a semiconductor memory device illustrated in FIG. 1, according to certain embodiments;

FIG. 3 is a diagram illustrating a case in which an even page is opened, according to an exemplary embodiment of the inventive concept;

FIG. 4 is a diagram illustrating a case in which an odd page is opened, according to an exemplary embodiment of the inventive concept;

FIG. 5 is a diagram illustrating a case in which a full page is opened, according to an exemplary embodiment of the inventive concept;

FIG. 6 is a diagram illustrating a half-page open operation according to an exemplary embodiment of the inventive concept;

FIG. 7 is a diagram illustrating a full page open operation according to an exemplary embodiment of the inventive concept;

FIG. 8 is a diagram illustrating a half-page open operation according to an exemplary embodiment of the inventive concept;

FIG. 9 is a diagram illustrating a full page open operation according to an exemplary embodiment of the inventive concept;

FIG. 10 is a block diagram illustrating a computing device according to an exemplary embodiment of the inventive concept;

FIG. 11 is a block diagram illustrating a portable multimedia device according to an exemplary embodiment of the inventive concept;

FIG. 12 is a block diagram illustrating a stack-type memory module according to an exemplary embodiment of the inventive concept; and

FIG. 13 is a block diagram illustrating a mobile electronic device according to an exemplary embodiment of the inventive concept.

Though the different figures show variations of exemplary embodiments, these figures are not necessarily intended to be mutually exclusive from each other. Rather, as will be seen from the context of the detailed description below, certain features depicted and described in different figures can be combined with other features from other figures to result in various embodiments, when taking the figures and their description as a whole into consideration.

### DETAILED DESCRIPTION

Various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure.

The term “include,” “comprise,” “including,” or “comprising” used herein indicates disclosed functions, operations, or existence of elements but does not exclude other functions, operations or elements. It should be further understood that the term “include”, “comprise”, “have”, “including”, “comprising”, or “having” used herein specifies the presence of stated features, integers, operations, elements, components, or combinations thereof but does not preclude the presence or addition of one or more other features, integers, operations, elements, components, or combinations thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “and/or” includes any and all combinations of one or more of the associated listed items and may be abbreviated as “/”.

It will be understood that, although the terms first, second, third etc. may be used herein to describe various elements, components, regions, layers and/or sections, these elements, components, regions, layers and/or sections should not be limited by these terms. Unless the context indicates otherwise, these terms are only used to distinguish one element, component, region, layer or section from another element, component, region, layer or section, for example as a naming convention. Thus, a first element, component, region, layer or section discussed below in one section of the specification could be termed a second element, component, region, layer or section in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements from each other.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

With regard to description of drawings, similar components may be marked by similar reference numerals.

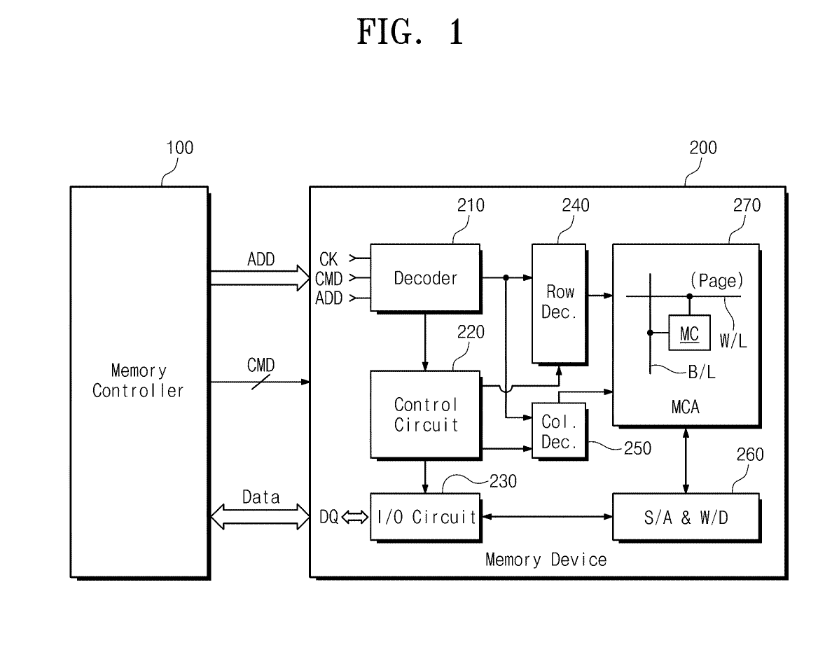

FIG. 1 is a block diagram schematically illustrating a memory system including a semiconductor memory device according to an exemplary embodiment of the inventive concept.

Referring to FIG. 1, a memory system may include a memory controller 100 such as an application processor and a semiconductor memory device 200 having a function such as an adaptive page size control.

When the memory system is applied to a mobile electronic device, the memory controller 100 may be a mobile AP, which is driven on an operating system such as Android™, iOS™, Windows' phone, Bada™, Blackberry™, or Symbian™. The semiconductor memory device 200 may be, for example, an LPDDR DRAM.

The memory controller 100 may provide a command CMD and an address ADDR to the semiconductor memory device 200. Here, the command CMD and the address ADDR may be separately provided through command/address (CA) pins. The memory controller 100 may provide write data to the semiconductor memory device 200.

As illustrated in FIG. 1, the semiconductor memory device 200 may include a decoder 210, a control circuit 220, an input/output (I/O) circuit 230, a row decoder 240, a sense amplifier and write driver (S/A & W/D) block 260, and a memory cell array 270.

The decoder 210 may decode an address and a command. The decoder 210 may receive and decode page size selection information. The page size selection information may be sent to the decoder 210 from the memory controller 100 in an on-the-fly (OTF) manner. Here, the OTF manner may mean that any information is provided along with a command and the information is applied when the command is executed.

The memory cell array 270 may include a plurality of pages for storing data. Here, a page may mean a data unit accessible with one row operation. So, a page may be a data unit that one or multiple word lines store, and describing that “a page is opened” (hereinafter referred to as “page open”) may mean that all memory cells connected to word lines of the page can be accessed. For example, in the case where one word line of a page includes 1024 memory cells, page open may mean that 1024 memory cells connected to the word line can be accessed. Describing the “half a page is opened” may mean that half of the 1024 memory cells connected to the selected word line can be accessed.

The memory cell array 270 may include a main array area where normal memory cells for storing data are arrayed, a dummy array area where dummy memory cells for allowing a normal operation of the normal memory cells are arrayed, and a redundancy area where spare memory cells for repairing defective normal memory cells are arrayed. The normal memory cells and the spare memory cells may be the same as each other in size and shape. A DRAM memory cell may include an access transistor and a storage capacitor.

According to an exemplary embodiment of the inventive concept, an access operation may mean turning on an access transistor of a memory cell to read or write data from or at the memory cell.

According to an exemplary embodiment of the inventive concept, an active operating mode may mean activating a page (or a word line) of the memory cell array 270 which is selected by a row address.

The control circuit 220 may decide whether a part or all of a selected page is opened in response to the page size selection information applied in an active operating mode.

According to an exemplary embodiment of the inventive concept, the control circuit 220 may receive the page size selection information in a page size open setting mode. Here, the page size selection information may be used to open a part or all of a page of the memory cell array 270. In the case where a part of a page is opened in an active operating mode where a page selected by a row address is opened, the control circuit 220 may perform control such that a part of the page to be opened is determined according to a part of bit information of a column address.

Pages of the memory cell array 270 may be selected by the row decoder 240, and bit lines thereof may be selected by the column decoder 250.

The row decoder 240 may decode a row address to activate a selected page (or a selected word line).

The column decoder 250 may decode a column address to select a bit line(s).

The S/A & W/D block 260 may amplify data read from a memory cell and may output the amplified data to the I/O circuit 230. The S/A & W/D block 260 may drive received write data such that the write data is stored at a selected memory cell.

The I/O circuit 230 may output read data to the memory controller 100. The I/O circuit 230 may receive write data to provide the receive write data to the S/A & W/D block 260.

In FIG. 1, an embodiment of the inventive concept illustrates a memory cell array 270 including DRAM cells. However, the scope and spirit of the inventive concept is not limited thereto. For example, the memory cell array 270 may include MRAM cells, rather than DRAM cells.

A volatile semiconductor memory device such as an SRAM or a DRAM may lose data stored therein at power-off, while a nonvolatile memory device such as a magnetic RAM (MRAM) may retain data stored therein even after power-off. Accordingly, the nonvolatile memory device may be used to store data to prevent data from being lost due to power failure or power interruption. In particular, if implemented with a spin transfer torque magneto resistive random access memory (STT-MRAM), a memory may have advantages of both the DRAM and the MRAM. An STT-MRAM cell may include a magnetic tunnel junction (MTJ) element and a selection transistor. The MTJ element may include a fixed layer, a free layer, and a tunnel layer formed between the fixed layer and the free layer. A magnetization direction of the fixed layer may be pinned, and a magnetization direction the free layer may be set according to a condition so as to be the same as or reverse to that of the fixed layer.

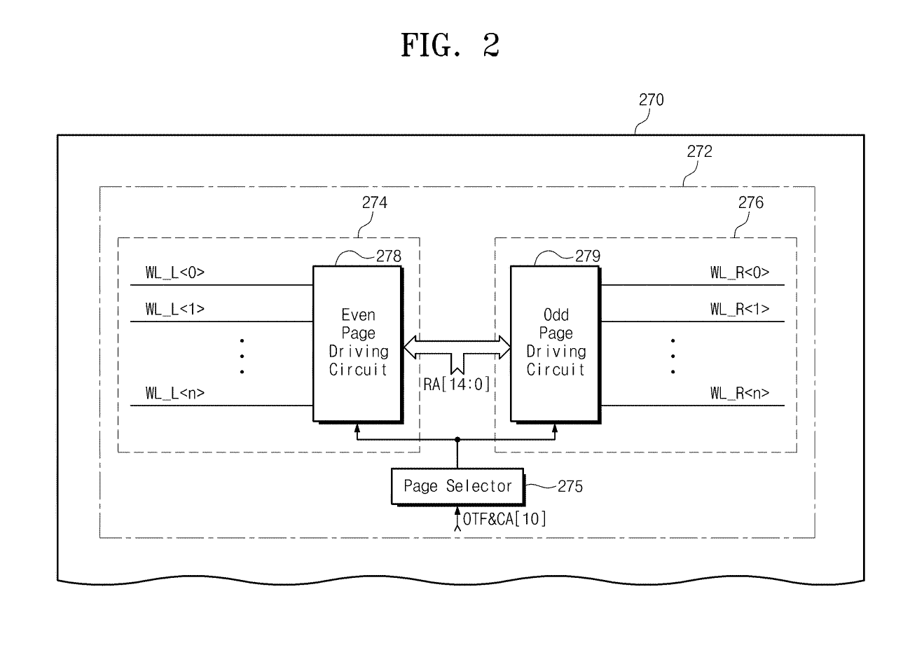

FIG. 2 is a block diagram schematically illustrating a part of a semiconductor memory device illustrated in FIG. 1, according to certain exemplary embodiments.

A block 272 of the memory cell array 270 may include an even page block 274 and an odd page block 276.

The even page block 274 may include a plurality of even pages WL_L<0> to WL_L<n> that an even page driving circuit 278 drives. The odd page block 276 may include a plurality of odd pages WL_R<0> to WL_R<n> that an odd page driving circuit 279 drives. Here, “n” may be a natural number of 2 or more and may mean the number of pages in a block.

The block 272 may be a memory block, a memory bank, or a memory rank.

One even page WL_L<0> and one odd page WL_R<0> may constitute one page. In the case where a first word line selected by a row address at a full-page open, the even page WL_L<0> and the odd page WL_R<0> may be activated at the same time.

In the case where a first word line selected by a row address at a half-page open, one of the even page WL_L<0> and the odd page WL_R<0> may be activated. Here, whether to activate the even page WL_L<0> or the odd page WL_R<0> may be determined according to an address different from the row address or any other information.

A page selector 275 of the block 272 may receive page size selection information with OTF manner. Furthermore, when the page size selection information indicates that a part of the selected page is opened, the page selector 275 may receive open page selection information to determine a part of a page to be opened. Here, the open page selection information may be a bit or bits included in the column address. For example, the bit included in the column address may be a most significant bit (MSB) of the column address. For example, a column address may be 11-bit, CA[10], the MSB of the column address bits, decides whether the even page driving circuit 278 or odd page driving circuit 279 may be driven.

In FIG. 2, where half the page is opened according to page size selection information of “0” applied with OTF manner, one of a plurality of pages may be selected by a row address RA[14:0]. For example, if a first word line WL<0> is selected by a row address at the half-page open mode, one of the even page WL_L<0> and the odd page WL_R<0> may be activated according to information (0 or 1) that the MSB CA[10] of a column address indicates. Since the odd page WL_R<0> may be inactivated if the MSB CA[10] of the column address is “0”, it may be possible to reduce power consumption when data read or write operation occurs only in the even page.

An active operation for activating a selected page may be a prerequisite for reading data in the page. A pre-charge operation may also be necessary to pre-charge a selected bit line with a pre-charge level to close an opened page. An operating current may be needed to perform the active operation and the pre-charge operation. As described above, in some embodiments, if the odd page WL_R<0> is inactivated according to half page selection, active operation or pre-charge operation for the odd page WL_R<0> is not necessary and thus activation current may be saved.

In some embodiments, when the whole of the selected page is opened in an active operating mode (the full-page open), selection of an even page and an odd page is not needed, and MSB CA[10] of a column address may be ignored. As such, MSB CA[10] of the column address may be regarded as “don't care” signal.

In FIG. 2, an embodiment of the inventive concept illustrates half-page open example. However, the scope and spirit of the inventive concept may not be limited thereto. For example, one page may be divided into four quarter-pages.

The two half-pages may be referred to as an even page and an odd page respectively. The two half-pages may also be referred to as left page and right page respectively.

According to an exemplary embodiment of the inventive concept, at the selection of whole page open mode, two word lines are enabled while one of the two word lines may be selected at the selection of a half-page open mode.

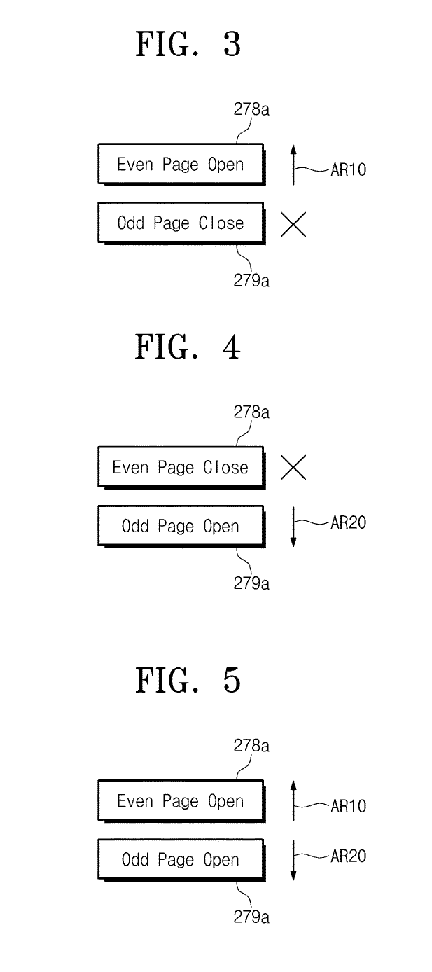

FIG. 3 is a diagram illustrating a case in which an even page is opened according to an exemplary embodiment of the inventive concept.

Referring to FIG. 3, in the case where half the page is opened according to page size selection information of “0” applied with the OTF manner, an even page 278a may be opened as marked by an arrow AR10, and an odd page 279a may be closed. In this case, an MSB CA[10] of a column address received may be logical value “0”.

FIG. 4 is a diagram illustrating a case in which an odd page is opened when selecting a page size, according to an exemplary embodiment of the inventive concept.

Referring to FIG. 4, in the case where half the page is opened according to page size selection information of “0” applied with the OTF manner, an odd page 279a may be opened as marked by an arrow AR20, and an even page 278a may be closed. In this case, an MSB CA[10] of a column address received may be logical value “1”.

FIG. 5 is a diagram illustrating a case in which a full page is opened when selecting a page size, according to an exemplary embodiment of the inventive concept.

Referring to FIG. 5, in the case where a full page is opened according to page size selection information of “1” applied with the OTF manner, an even page 278a may be opened as marked by an arrow AR10, and an odd page 279a may be opened as marked by an arrow AR20. In this case, information of an MSB CA[10] may be regarded as “don't care” signal.

According to an exemplary embodiment of the inventive concept, that a page is opened (or the page open) may mean an active or enable operation of a word line or a page.

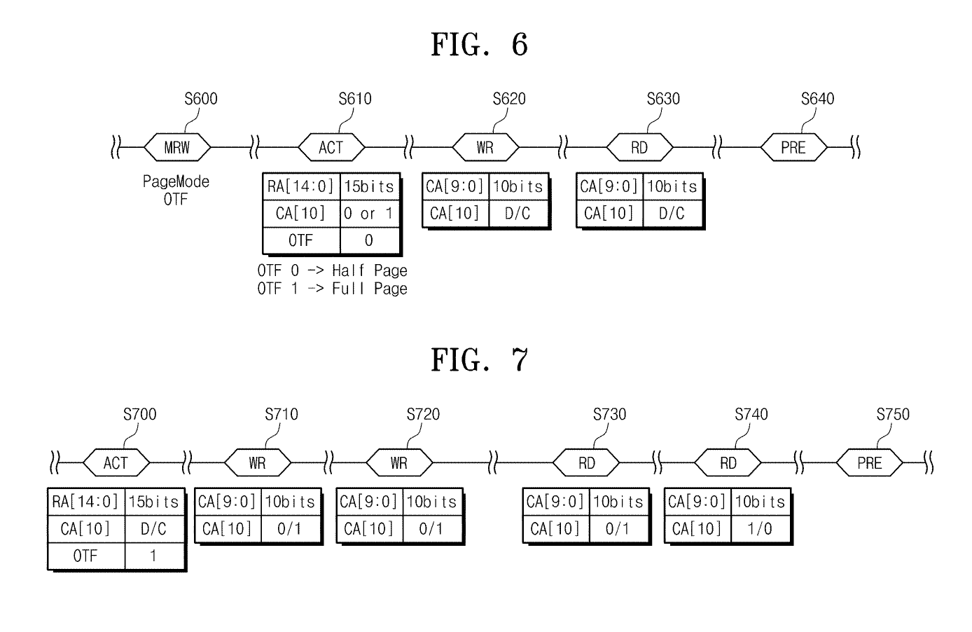

FIG. 6 is a diagram illustrating a half-page open operation according to an exemplary embodiment of the inventive concept.

In FIG. 6, a half-page open operation at read and write operations is illustrated in the case of providing page size selection information with the OTF manner.

In step S610, an active command for activating a page selected by a row address may be received before a write command and a read command (S620, S630).

Before the active command is received (S610), in step S600, a page operating mode may be set to inform that the page size selection information is designated with the OTF manner.

Mode register write (MRW) performed in setting the page operating mode (S600) may mean setting a mode in a mode register set (MRS) mode. For example, a page operating mode where the page size selection information is designated with the OTF manner may be set by applying “10” in an MRS mode. The page size selection information may be previously set to indicate a half-page by applying “00” in an MRS mode.

An embodiment of the inventive concept is exemplified as the page operating mode is set through the MRS mode in step S600. However, the scope and spirit of the inventive concept is not limited thereto. The page operating mode may be set through a fuse option or any other methods.

In step S610, the memory controller 100 may apply the page size selection information to the semiconductor memory device 200 with the OTF manner. For example, it is assumed that page size selection information of “0” indicates the half-page open and page size selection information of “1” indicates the full-page open. Referring to FIG. 6, the active command may indicate the half-page open by applying “0” for the page size selection information in step S610.

Furthermore, the memory controller 100 may apply a row address for selecting a page to the decoder 210 of the semiconductor memory device 200. For example, in the case where a 15-bit row address RA[14:0] is applied, one of a plurality of pages may be selected.

As described with reference to FIGS. 3 and 4, the memory controller 100 may provide the decoder 210 of the semiconductor memory device 200 with open page selection information indicating whether to select an even page or an odd page of the selected page. Here, the open page selection information may be a bit or bits of a column address, for example, MSB of the column address. In the case where a column address is an 11-bit column address, an even page of the selected page may be opened when a bit CA[10] being an MSB is “0”, and an odd page of the selected page may be opened when a bit CA[10] being an MSB is “1”.

In step S610 where the active command is applied, when a row address is applied, an even page or an odd page may be selected if the page size selection information and the open page selection information are given with the OTF manner, as illustrated in FIG. 3 or 4. For example, in the case where an even page is opened, memory cells connected to the even page may be accessed for a read operation or a write operation.

In step S620 where a write command is applied, a 10-bit column address may be used to select a column including bit lines. For example, in the case where a column address is an 11-bit address, since information of a bit CA[10] being an MSB is used as open page selection information, it may be ignored in step S620, and remaining 10 bits of the column address other than the MSB may be used to select bit lines. Accordingly, CA[10] may be regarded as “don't care” signal.

In step S620 where the write command is applied, data may be written into memory cells connected to a selected half-page.

In step S630 where a read command is applied, 10 bits of the column address may be used to select a column. In the case where a column address is a 11-bit address, since information of a bit CA[10] being an MSB is used as the open page selection information, it may be ignored in step S630, and remaining 10 bits of the column address other than the MSB may be used to select bit lines. Accordingly, CA[10] may be regarded as “don't care” signal.

Data may be read from memory cells connected to a half-page, selected in step S630 where the read command is applied, for example through a sense amplifier.

If the write and read operations are completed, in step S640, a pre-charge operation may be performed to close the opened half-page.

As described above, since half the page may be opened in steps S610, S620, and S630, power consumption may be reduced compared with full page open operation.

FIG. 7 is a diagram illustrating a full-page open operation according to an exemplary embodiment of the inventive concept.

Referring to FIG. 7, in step S700 where an active command is applied, the memory controller 100 may apply the page size selection information to the semiconductor memory device 200 with the OTF manner. For example, it may be set for full page open when the page size selection information of is “0” and may be set for half the page open when the page size selection information of is “1”. Referring to FIG. 7, the active command applied in step S700 may be a command indicating full-page open because the page size selection information of “1” is applied thereto.

Furthermore, the memory controller 100 may provide the semiconductor memory device 200 with a row address for selecting a page. For example, in the case where a 15-bit row address RA[14:0] is applied, one of a plurality of pages may be selected.

For the full-page open, as described with reference to FIG. 5, the open page selection information may not be needed. For example, information of an MSB CA[10] of a column address may be ignored. As such, the information of the MSB CA[10] may be regarded as “don't care” signal.

Accordingly, in step S700 where the active command is applied, if the page size selection information is given with the OTF manner when a row address is applied, a full page may be opened as described with reference to FIG. 5. In this case, memory cells connected to even and odd pages may be accessed for a read operation or a write operation.

In step S710 where a write command is applied, an 11-bit column address may be used to select a column including bit lines. For example, in the case where a column address is a 11-bit address, information of a bit CA[10] being an MSB and remaining 10 bits of the column address other than the MSB may be used to select bit lines.

In step S710 where the write command is applied, data may be written at memory cells connected to a selected full-page.

Step S720 may be the same as step S710 except different information of MSBs CA[10]. In the case where information of MSBs CA[10] is different from each other, a column, for example, a bit line may be selected according to information of a bit CA[10] and remaining 10 bits of the column address.

In steps S730 and 740 in each of which a read command is applied, 11 bits of the column address may be used to select a column including bit lines. For example, in the case where a column address is a 11-bit address, information of a bit CA[10] being an MSB and remaining 10 bits CA[9:0] of the column address may be used to select bit lines.

In S730 and 740 in each of which the read command is applied, data may be read from memory cells connected to a selected full-page.

Step S740 may be the same as step S730 except for different information of MSBs CA[10]. In the case where information of MSBs CA[10] is different from each other, a column, for example, a bit line may be selected according to information of a bit CA[10] and remaining 10 bits of the column address.

If the write or read operation is completed, in step S750, a pre-charge operation may be performed to close the opened full-page.

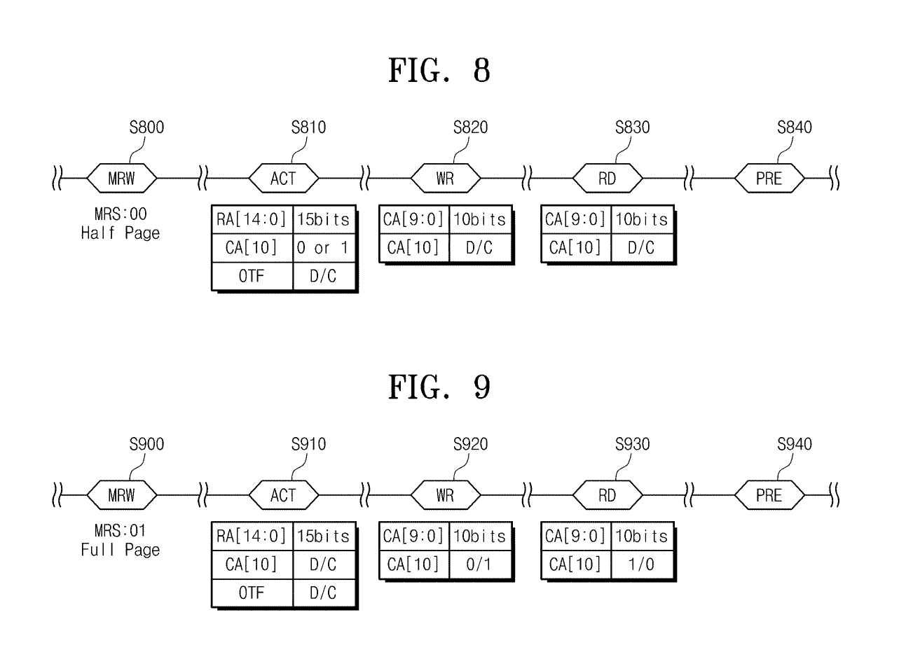

FIG. 8 is a diagram illustrating a half-page open operation according to another exemplary embodiment of the inventive concept.

An embodiment of the inventive concept is exemplified in FIG. 8 as page size selection information is designated in the MRS manner, not the OTF manner.

Mode register write (MRW) performed in setting the page operating mode in step S800 may mean defining a page selection mode in the MRS mode. For example, in the case where “00” is applied in an MRS mode, the page size selection information may be set to indicate a half-page.

In step S810 where an active command is applied, the memory controller 100 may provide the decoder 210 of the semiconductor memory device 200 with a row address for selecting a page. For example, in the case where a 15-bit row address RA[14:0] is applied, one of a plurality of pages may be selected.

As described with reference to FIGS. 3 and 4, the memory controller 100 may provide the decoder 210 of the semiconductor memory device 200 with the open page selection information indicating whether to select an even page or an odd page of a selected page. Here, the open page selection information may be given using a part of bit information of a column address, for example, state information of an MSB of a column address. In the case where a column address is an 11-bit address, an even page of the selected page may be opened when a bit CA[10] being an MSB is “0”, and an odd page of the selected page may be opened when a bit CA[10] being an MSB is “1”.

In step S810 where an active command is applied, if the open page selection information is given when a row address is applied, an even page or an odd page may be opened as described with reference to FIG. 3 or 4. For example, in the case where an even page is opened, memory cells connected to the opened even page may be accessed for a read or write operation.

In this case, information applied with the OTF manner may be ignored.

In step S820 where a write command is applied, 10 bits of a column address may be valid. For example, in the case where a column address is a 11-bit address, since information of a bit CA[10] being an MSB is used as the open page selection information, it may be ignored in step S820, and remaining 10 bits of the column address other than the MSB may be valid to select bit lines. Accordingly, CA[10] may be regarded as “don't care” signal.

Data may be written at memory cells connected to a half-page selected in step S820 where the write command is applied.

In step S830 where a read command is applied, 10 bits of the column address may be valid. For example, in the case where a column address is a 11-bit address, since information of a bit CA[10] being an MSB is used as the open page selection information, it may be ignored in step S830, and remaining 10 bits of the column address other than the MSB may be valid to select bit lines. Accordingly, CA[10] may be regarded as “don't care” signal.

Data may be read from memory cells connected to a half-page, selected in step S830 where the read command is applied, through a sense amplifier.

If a write or read operation is completed, in step S840, a pre-charge operation may be performed to close the opened half-page.

As described above, since half the page is opened in steps S810, S820, and S830, power consumption at active and pre-charge operations may be reduced compared to the case that a full page is opened.

FIG. 9 is a diagram schematically illustrating a full page open operation according to another exemplary embodiment of the inventive concept.

Referring to FIG. 9, mode register write (MRW) performed in setting the page operating mode in step S900 may mean defining a page selection mode in the MRS mode. For example, in the case where “01” is applied in an MRS mode, the page size selection information may be set to indicate a full page.

In step S910 where an active command is applied, the memory controller 100 may provide the decoder 210 of the semiconductor memory device 200 with a row address for selecting a page. For example, in the case where a 15-bit row address RA[14:0] is applied, one of a plurality of pages may be selected.

For the full-page open, as described with reference to FIG. 5, the open page selection information may not be needed. For example, information of an MSB CA[10] of a column address may be ignored. As such, the information of the MSB CA[10] may be regarded as “don't care” signal. In this case, information applied with the OTF manner may be also ignored.

Accordingly, if a row address is applied in step S910 where the active command is applied, a full page may be opened as described with reference to FIG. 5. In this case, memory cells connected to even and odd pages may be accessed for a read operation or a write operation.

In step S920 where a write command is applied, 11 bits of a column address all may be used. For example, in the case where a column address is a 11-bit address, information of a bit CA[10] being an MSB and remaining 10 bits of the column address other than the MSB may be used to select bit lines.

In step S920 where the write command is applied, data may be written at memory cells connected to a selected full-page.

In step S930 where a read command is applied, 11 bits of the column address all may be used. For example, in the case where a column address is a 11-bit address, information of a bit CA[10] being an MSB and remaining 10 bits CA[9:0] of the column address other than the MSB may be used to select bit lines.

Data may be read from memory cells connected to a full page selected in step S930 where the read command is applied.

If the write or read operation is completed, in step S940, a pre-charge operation may be performed to close the opened full-page.

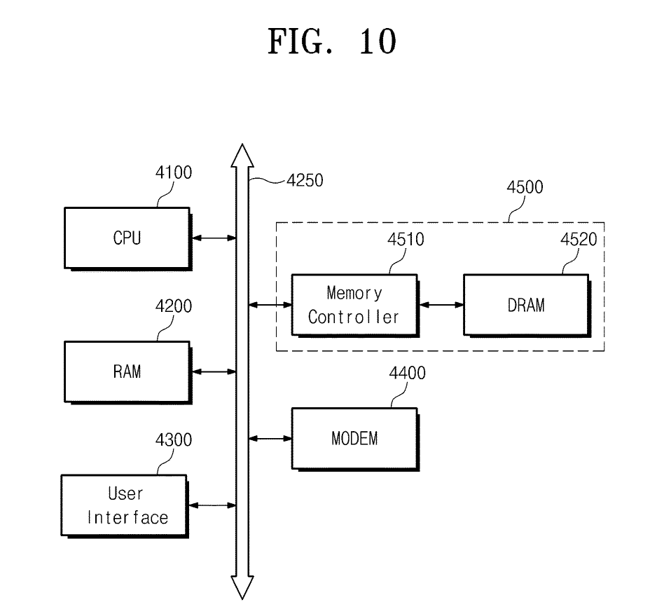

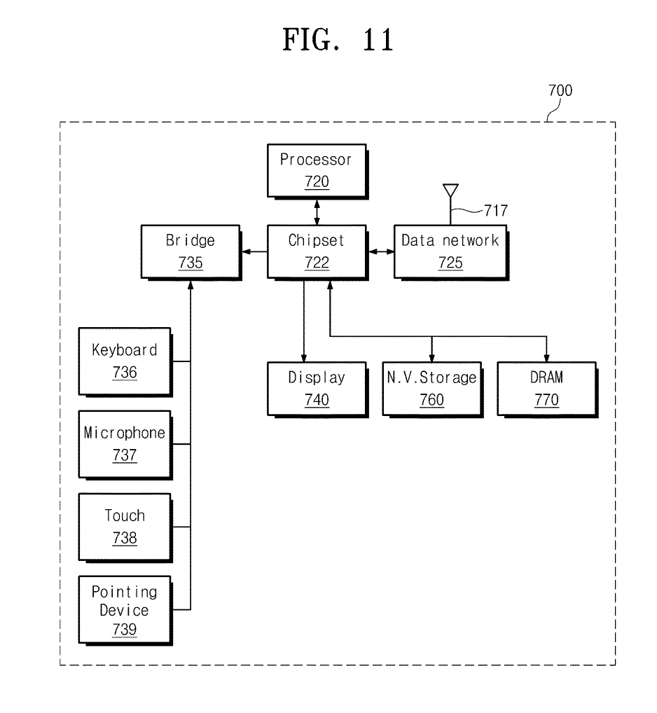

FIG. 10 is a block diagram schematically illustrating a computing device according to an exemplary embodiment of the inventive concept.

Referring to FIG. 10, a computing device may include a memory system 4500 which includes a memory controller 4510 and a DRAM 4520. The computing device may include an information processing device or a computer. For example, the computing device may further include a modem 4250, a central processing unit (CPU) 4100, a RAM 4200, and a user interface 4300, which are electrically connected to a system bus 4250, as well as the memory system 4500. Data processed by the CPU 4100 or data input from an external device may be stored in the memory system 4500.

The computing device may be applied to a solid state disk, a camera image sensor, an application chipset, and like. For example, the memory system 4500 may be implemented with a solid state drive (SSD). In this case, the computing device may store mass data at the memory system 4500.

In the memory system 4500, the memory controller 4510 may send a command, an address, data, and any other control signals to the DRAM 4520.

The CPU 4100 may function as a host and may control an overall operation of the computing device.

A host interface between the CPU 4100 and the memory controller 4510 may include a variety of protocols for changing exchange between the memory controller 4510 and a host. In exemplary embodiments, the memory controller 4510 may be configured to communicate with the host or an external device through at least one of various protocols including the following: universal serial bus (USB) protocol, multimedia card (MMC) protocol, peripheral component interconnection (PCI) protocol, PCI-express (PCI-E) protocol, advanced technology attachment (ATA) protocol, serial-ATA protocol, parallel-ATA protocol, small computer small interface (SCSI) protocol, enhanced small disk interface (ESDI) protocol, and integrated drive electronics (IDE) protocol.

The computing device shown in FIG. 10 may be provided as one of various components of an electronic device, such as a computer, a ultra-mobile personal computer (UMPC), a digital picture player, a digital video recorder, a digital video player, storage forming a data center, a device for transmitting and receiving information in a wireless environment, one of various electronic devices constituting a home network, one of various electronic devices constituting a computer network, one of various electronic devices constituting a telematics network, a radio frequency identification (RFID) device, and one of various components constituting a computing system.

The DRAM 4520 may adaptively adjust the size of a page to be opened at an access operation as described with reference to FIG. 1 or 2, thereby reducing or minimizing power consumption of the computing device.

The memory system 4500 of the computing device illustrated in FIG. 10 may be packaged according to any of a variety of different packaging technologies. Examples of such packaging technologies may include the following: package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), small outline (SOIC), shrink small outline package (SSOP), thin small outline (TSOP), thin quad flatpack (TQFP), system in package (SIP), multi-chip package (MCP), wafer-level fabricated package (WFP), and wafer-level processed stack package (WSP).

FIG. 11 is a block diagram illustrating a portable multimedia device according to an exemplary embodiment of the inventive concept.

Referring to FIG. 11, a portable multimedia device 700 may include a processor 720, a chipset 722, a data network 725, a bridge 735, a display 740, nonvolatile storage 760, a DRAM 770, a keyboard 736, a microphone 737, a touch unit 738, and a pointing device 739. The DRAM 770 which is configured as illustrated in FIG. 1 or 2 may adaptively adjust the size of a page to be opened at an access operation, thereby reducing or minimizing power consumption of the portable multimedia device 700.

The chipset 722 may provide the DRAM 770 with a command, an address, data, or any other control signals.

The processor 720 may function as a host and may control an overall operation of the portable multimedia device 700.

A host interface between the processor 720 and the chipset 722 may include a variety of protocols for data communications.

The nonvolatile storage 760 may be implemented with an electrically erasable programmable read-only memory (EEPROM), a flash memory, a magnetic RAM (MRAIVI), a spin-transfer torque MRAIVI (STT-MRAIVI), a conductive bridging RAM (CBRAM), a ferroelectric RAM (FeRAIVI), a phase change RAM (PRAM) called OUM (Ovonic Unified Memory), a resistive RAM (RRAM or ReRAM), a nanotube RRAM, a polymer RAM (PoRAM), a nano floating gate memory (NFGM), a holographic memory, a molecular electronics memory device, or an insulator resistance change memory.

The portable multimedia device 700 illustrated in FIG. 11 may be changed or expanded as one of various components of an electronic device, such as a computer, a ultra-mobile personal computer (UMPC), a workstation, a net-book, a personal digital assistance (PDA), a portable computer (PC), a web tablet, a wireless phone, a mobile phone, a smart phone, a smart television, a three-dimensional television, an e-book, a portable multimedia player (PMP), a portable game console, a navigation device, a black box, a digital camera, a digital multimedia broadcasting (DMB) player, a digital audio recorder, a digital audio player, a digital picture recorder, a digital picture player, a digital video recorder, a digital video player, storage as a data center, a device for transmitting and receiving information in a wireless environment, one of various electronic devices constituting a home network, one of various electronic devices constituting a computer network, one of various electronic devices constituting a telematics network, a radio frequency identification (RFID) device, or one of various components constituting a computing system.

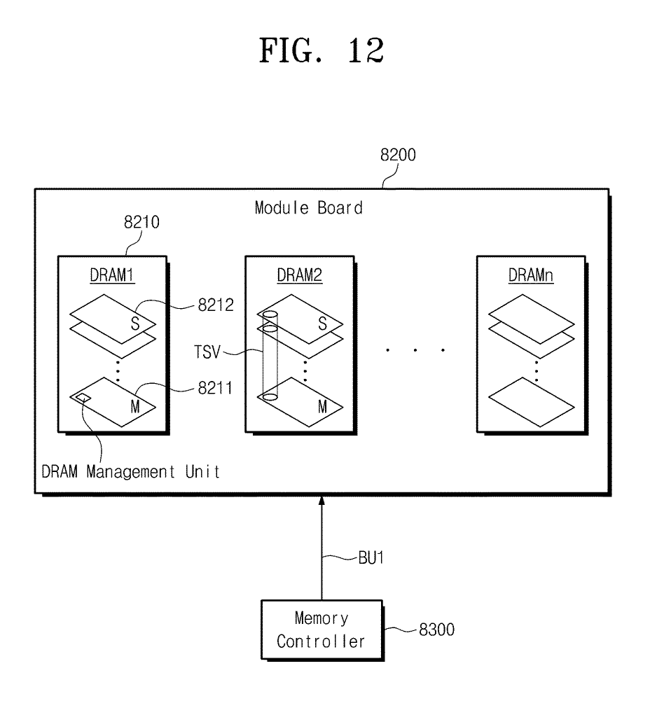

FIG. 12 is a block diagram illustrating a stack-type memory module according to an exemplary embodiment of the inventive concept. For descriptive convenience, a memory controller 8300 may be illustrated together with a memory module.

As illustrated in FIG. 12, a memory module 8200 may include one or more semiconductor memory devices 8210 mounted on a module board. The semiconductor memory device 8210 may be a DRAM chip. Each of the semiconductor memory devices 8210 may include a plurality of semiconductor layers. The semiconductor layers may include one or more master chips 8211 and one or more slave chips 8212.

Signal transmission between the semiconductor layers may be performed using through silicon vias (TSVs). The memory module 8200 may communicate with the memory controller 8300 through a system bus such that a command CMD/CMD CPL, an address ADD, a flag, and information bits are transmitted and received between the memory module 8200 and the memory controller 8300.

The semiconductor memory device 8210 which is configured as illustrated in FIG. 1 or 2 may open a page size adaptively, thereby reducing power consumption at a memory access operation. This may mean that power consumption of the memory module 8200 is reduced.

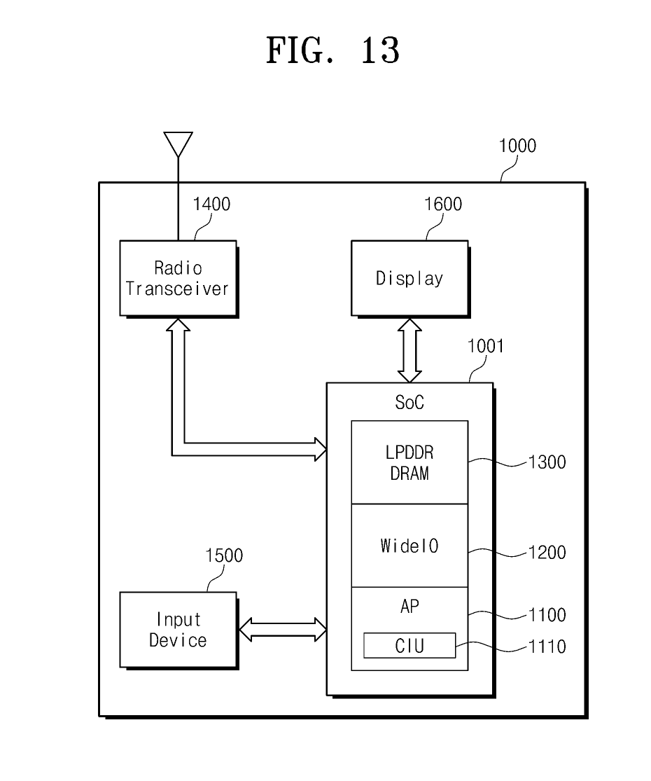

FIG. 13 is a block diagram illustrating a mobile electronic device according to an exemplary embodiment of the inventive concept.

A mobile electronic device 1000 illustrated in FIG. 13 may be a device with a wireless internet function such as a cellular phone, a smart phone, or a tablet PC.

Referring to FIG. 13, the mobile electronic device 100 may include a system on chip (SoC) 1001. The SoC 1001 may be manufactured in the form of a package on package (PoP). The SoC 1001 may include an application processor 1100, a WideIO memory 1200, and an LPDDR DRAM 1300. Here, the LPDDR DRAM 1300 may mean a low-power DDRx DRAM (x being an integer of 3 or more).

In the case where a channel interleaving unit 1110 is implemented in the application processor 1100, it may perform a channel interleaving operation between the WideIO memory 1200 and the LPDDR DRAM 1300.

A radio transceiver 1400 may receive and transmit wireless signals through an antenna. For example, the radio transceiver 1400 may convert wireless signals received through the antenna into signals that the SoC 1001 is capable of processing. The SoC 1001 may perform data processing about signals from the radio transceiver 1400, and it may store the processed data at the WideIO memory 1200 or the LPDDRx memory or may display the processed data through a display 1600.

Furthermore, the radio transceiver 1400 may convert signals from the SoC 1001 into wireless signals and may output the converted wireless signals to the outside through the antenna.

An input device 1500 may be a device which receives control signals for controlling an operation of the SoC 1001 or data to be processed by the SoC 1001 and may be a pointing device, such as a touch pad or a computer mouse, a keypad, or a keyboard.

The SoC 1001 may control an operation of the display 1600 such that data from the WideIO memory 1200 or the LPDDR DRAM 1300, wireless signals from the wireless transceiver 1400, or data from the input device 1500 is displayed through the display 1600.

In FIG. 13, an embodiment of the inventive concept is exemplified as the SoC 1001 includes the WideIO memory 2200 and the channel interleaving unit 2110. However, the LPDDR DRAM 1300 may be independently provided outside or inside the SoC 100 lwhich does not include the WideIO memory 2200 and the channel interleaving unit 2110.

The mobile electronic device of FIG. 13 may include the LPDDR DRAM 1300 with a page size adjustment function described with reference to FIG. 1 or 2, thereby reducing power consumption of the mobile electronic device.

According to an exemplary embodiment of the inventive concept, it may be possible to reduce or minimize power consumption when a page is opened for a read operation or a write operation.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

In some cases, a page size adjusting manner may be variously changed or modified by changing circuit components of drawings or adding or subtracting components without departing from the spirit and scope of the inventive concept. Also, an embodiment of the inventive concept is exemplified as a semiconductor memory device includes a DRAM. However, the scope and spirit of the inventive concept is not limited thereto.

What is claimed is:

1. A semiconductor memory device comprising:
a memory cell array including a plurality of pages, each page configured to be opened by an active operation;
a decoder configured to decode an address and a command; and
a control circuit configured to open a part or all of a selected page in response to page size selection information applied during the active operation.

2. The semiconductor memory device of claim 1, configured such that the page size selection information is applied to the decoder in an on the fly (OTF) manner.

3. The semiconductor memory device of claim 1, configured such that the page size selection information indicates that a part of the selected page is opened, and the portion of the selected page to be opened is determined according to open page selection information.

4. The semiconductor memory device of claim 3, wherein the open page selection information is a bit or bits of a column address.

5. The semiconductor memory device of claim 4, wherein the open page selection information bit is a most significant bit (MSB) of the column address.

6. The semiconductor memory device of claim 4, configured such that when the whole of the selected page is opened, the information of the open page selection information bit is ignored.

7. The semiconductor memory device of claim 4, wherein a part of the selected page is an even page or an odd page of the selected page.

8. The semiconductor memory device of claim 1, configured such that the page size selection information is applied to the decoder in an on the fly (OTF) manner, and wherein an operating for the OTF manner is performed during a mode register set mode before the active operating mode.

9. The semiconductor memory device of claim 1, configured such that if a part of the selected page is opened, a selection of columns in a write operating mode is performed by decoding the column address except the open page selection information bit.

10. The semiconductor memory device of claim 1, configured such that if a part of the selected page is opened, a selection of columns in a read operating mode is performed by decoding the column address except the open page selection information bit.

11. A semiconductor memory device comprising:
a memory cell array including a plurality of pages to which a plurality of memory cells for storing data are connected and which are selected by a row address;
a decoder configured to decode an address and a command; and
a control circuit configured to receive page size selection information, indicating whether a part or all of a page of the memory cell array is opened,
wherein the semiconductor memory device is configured such that if a part of a page selected by the row address is opened in an active operating mode, the portion of the page to be opened is determined according to a bit or bits of a column address.

12. The semiconductor memory device of claim 11, configured such that the page size selection information is set in a mode register set mode.

13. The semiconductor memory device of claim 11, wherein the page selection information bit is an MSB of the column address.

14. The semiconductor memory device of claim 11, configured such that the page selection information bit of the column address is ignored when the whole of the page is opened in the active operating mode.

15. The semiconductor memory device of claim 11, wherein the portion of the page is half the page or a quarter of the page.

16. A semiconductor memory device comprising:
a memory cell array including a plurality of pages to which a plurality of memory cells for storing data is connected;
a decoder configured to decode an address and a command; and
a control circuit,
wherein the control circuit is configured to open a part or all of a selected page based on page size selection information applied from a memory controller during an active operating mode during which the selected page is activated.

17. The semiconductor memory device of claim 16, configured such that the page size selection information is applied to the decoder from the memory controller with OTF manner.

18. The semiconductor memory device of claim 16, wherein the page size selection information indicates whether a part of the selected page is opened, the portion of the selected page to be opened is determined according to MSB of a column address.

19. The semiconductor memory device of claim 16, wherein the portion of the selected page is half the selected page or a quarter of the selected page.

20. The semiconductor memory device of claim 16, configured such that the page size selection information is applied to the decoder with OTF manner, wherein an operating setting using the OTF manner is performed in a mode register set mode before the active operating mode.
